(19) United States
(12) Patent Application Publication
(10) Pub. No.: US 2011/0241530 A1
(43) Pub. Date: Oct. 6, 2011

(54) ELECTRICAL LAMP HAVING AN OUTER BULB AND A BUILT-IN LAMP

(75) Inventors: Eric Korndoerfer, Herbrechtingen (DE); Christoph Mahler, Illertissen (DE); Roland Stark, Wellheim (DE)

(73) Assignee: OSRAM GESELLSCHAFT MIT BESCHRAENKTER HAFTUNG, Muenchen (DE)

(21) Appl. No.: 13/140,442

(22) PCT Filed: Nov. 11, 2009
(86) PCT No.: PCT/EP09/64982

§ 371 Date: Jun. 17, 2011

(30) Foreign Application Priority Data
Dec. 19, 2008 (DE) 20 2008 016 865.1

(51) Int. Cl. H01J 5/48

(52) U.S. Cl. 313/318.01

(57) ABSTRACT

An electrical lamp may include an outer bulb and a built-in lamp arranged therein, and a longitudinal axis, a base being attached to the outer bulb, the built-in lamp being fitted with a pinch from which at least one outer power supply lead protrudes which, in turn, is electrically conductively connected by a connecting means to a supply cable, hereinafter called a base pin, extending upwards from the base wherein the connecting means is an assembly clip which comprises a frame part, the frame part connecting a hollow rail to a contact part, the contact part being connected to the outer power supply lead and the hollow rail being connected to the base pin.

### TECHNICAL FIELD

The invention proceeds from a lamp according to the preamble of claim 1. The invention relates in particular to an electrical lamp having a built-in lamp arranged in an outer bulb, and a base, the base being electrically conductively connected to power supply wires of the built-in lamp. The invention also relates to an electrical lamp fitted into a base at one side and having an outer bulb retained in a base and at least one built-in lap arranged inside the outer bulb. Halogen lamps of this kind are intended in particular for operation at high voltage (HV) at typically 100 to 250 V.

### PRIOR ART

DE-A 10 2005 051 076 discloses a retaining device for a built-in lamp, including a metal assembly clip into which the built-in lamp is inserted. The assembly clip is attached to the glass plate base of the outer bulb, and this is very costly as the glass base is a very complex component which, for example, includes an exhaust tube and fused-in lead wires.

### DESCRIPTION OF THE INVENTION

The object of the present invention is to ensure assembly of a built-in lamp on a plate base with an optimally short overall length.

This object is achieved by the characterizing features of claim 1.

Particularly advantageous embodiments are found in the dependent claims.

The invention ensures simple production of a lamp including a built-in lamp, a base and an outer bulb. The invention creates an electrical lamp that is fitted into a base on one side and having an outer bulb secured to a base and a built-in lamp, which is robust and easy to produce, arranged inside the outer bulb.

The built-in lamp is preferably a high-volt halogen lamp with pin base, at least two pins acting as power supply wires.

The built-in lamp substantially includes a hermetically sealed lamp vessel, at least one light means and a power supply system for the light means, which usually consists of two pins which project axially parallel out of a pinch in the built-in lamp. The light means is normally a luminous element but may also be a discharge arc between two electrodes. The light means will hereinafter always be described as a luminous element for the sake of simplicity.

The power supply system connects the luminous element arranged inside the lamp vessel to a base arranged outside the lamp vessel and which is to be connected to a power source. The power supply system consists, for example, of inner power supply wires, made of fusible foils and of outer power supply wires, with the ends of the inner and outer power supply wires that are aligned with each other and the fusible foils that connect the power supply wires together being fused in the lamp pinch. Only the pinch and the pins projecting outwards therefrom are relevant to the invention. The built-in lamp is usually filled with an inert gas and a halogen additive. Instead of a filament lamp a high pressure discharge lamp may also be used as the built-in lamp, however, similar to that described in DE-A 32 32 207.

The spirit of the invention lies in the fact that a high compactification is achieved in that the outer power leads of the built-in lamp are not directly connected to the base as has previously been conventional but by an assembly clip which, as it were, folds the connecting section and thus reduces the length of the lamp. For this purpose the outer power leads of the built-in lamp end as short pins. The assembly clip contacts one pin via a contact part but it does have a hollow rail, which is connected by a frame part to the contact part. This hollow rail is connected by a clip connection to a base pin which projects upwardly from a plate base.

What is essential to the reduction in the overall length is that there is a cutting plane in which the four electrical leads, namely the two outer power leads and the associated base contacts, do not have any physical contact with each other. Instead this contact is produced by the assembly clip in each case.

The novel assembly clip has as essential components a contact face for the outer power lead on the contact part, a frame part acting as a connection and a hollow rail which is connected to the contact part by the frame part.

The frame part is designed in particular in the manner of a window frame, i.e. substantially a quadrilateral which is inwardly recessed to save material. The quadrilateral is not necessarily planar, instead it can advantageously be undulating to improve stability.

The frame part is preferably constructed from two longitudinal struts and two cross struts. The contact part is substantially preferably a downward extension of a first longitudinal strut that faces away from the pinch. The contact part is slat-like, the contact face sits on the end of the contact part. It may be designed so as to be spade-shaped or ridge-like by beveling one side of the contact face and bending a protrusion at this location. This arrangement is used to spread the end of the outer supply lead.

The frame preferably has a slightly bent threading aid attached to the first longitudinal strut. It protrudes at the first longitudinal strut so as to be opposed to the contact part.

The hollow rail runs parallel to the second longitudinal strut. It is U-shaped in cross-section and attaches integrally to the second longitudinal strut with a leg of the U. This leg is bent substantially at a right angle out of the plane of the frame part. This hollow rail is adapted in such a way that it closely surrounds the protrusion of the base part. For provisional fixing the hollow rail can be open in the region of the second free leg, so a clamping piece is loosened from the substance of the second free leg which can be inclined inwards toward the base part and therefore pressed onto the base part.

In a preferred embodiment a further second frame part is attached to the second free leg and substantially matches the first frame part. However, it does not necessarily require a second longitudinal strut since this task can be assumed by the hollow rail. This second frame part preferably also has a threading aid, mirror-inverted to the first threading aid. It can be designed as a spring part in that it is undulating. This second frame part is used overall for improved fixing, stabilizing and force distribution during retention in that it is arranged over a wide area at a wide side of the pinch.

Two identical assembly clips are particularly preferably used which each connect a base contact to an outer supply lead.

### BRIEF DESCRIPTION OF THE DRAWINGS

The invention shall be described in more detail hereinafter with reference to a plurality of exemplary embodiments. In the figures:

FIG. 1 shows an exploded drawing of an inventive lamp,

FIG. 2 shows a plate base with clip in a side view (2a) and with built-in lamp secured thereto in side views rotated by 90° (2b, 2c, 2d),

FIG. 3 shows a cross-section through the pinch with clip,

FIG. 4 shows a perspective view of an assembly clip as used in FIGS. 1 to 3,

FIG. 5 shows a plate base with another clip in a side view (5a) and with built-in lamp secured thereto in side views rotated by 90° (5b, 5c, 5d),

FIG. 6 shows a cross-section through the pinch with clip according to FIG. 5,

FIG. 7 shows a perspective view of an assembly clip as used in FIG. 5,

FIG. 8 shows a perspective view of a further exemplary embodiment of an assembly clip.

### PREFERRED EMBODIMENT OF THE INVENTION

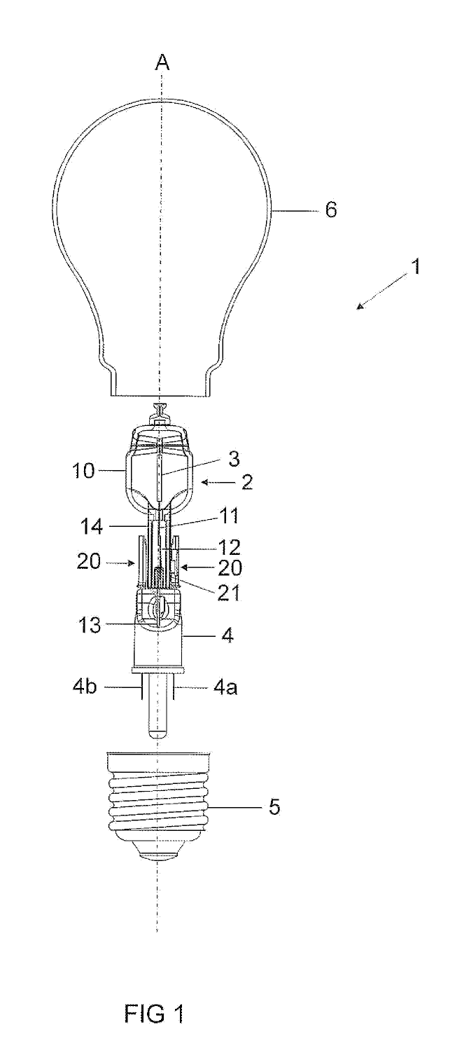

FIG. 1 shows an inventive lamp 1 in an exploded view. An outer bulb 6 of the A55 type is held in a base 5 of the commercial E27 type. A built-in lamp 2 is arranged inside the outer bulb 6 in such a way that a luminous element 3 of the built-in lamp 2 is located approximately at the point inside the outer bulb 6 at which the luminous element is also arranged in a conventional filament lamp. The built-in lamp 2 is designed as what is known as a high-volt halogen lamp and is known as such from the prior art.

The lamp 1 has a longitudinal axis A and also has a plate base 4 from which base contacts 4a, 4b project in the direction of the base.

The built-in lamp 2 is, for example, a halogen lamp pinched at one side. This halogen lamp includes a built-in lamp with lamp vessel 10. The luminous element 3 is electrically conductively connected to the base 5 by a power supply system. The power supply system consists of inner power supply wires 11 connected to the luminous element 3, fusible foils 12 and outer power supply wires 13 which are designed as short pins. The ends, facing away from the luminous element 3, of the inner power supply wires 11, the fusible foils 12 and the ends, facing the fusible foils, of the outer supply wires 13 are fused in a pinch 14, which terminates the lamp vessel 10. The pinch is provided, as is known per se, with two narrow sides 15 and two wide sides 16. The pinch 14 is preferably designed in what is referred to as a double T form, with a projecting bead 17 on the lateral edges.

The lamp vessel 10 is filled with an inert gas and halogen additive. At its end opposing the pinch 14 the lamp vessel 10 is fused. The lamp vessel 10 is outwardly hermetically sealed.

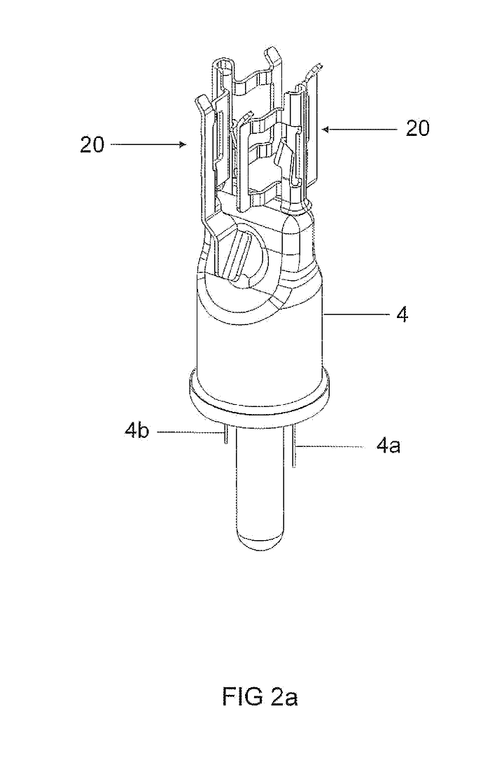

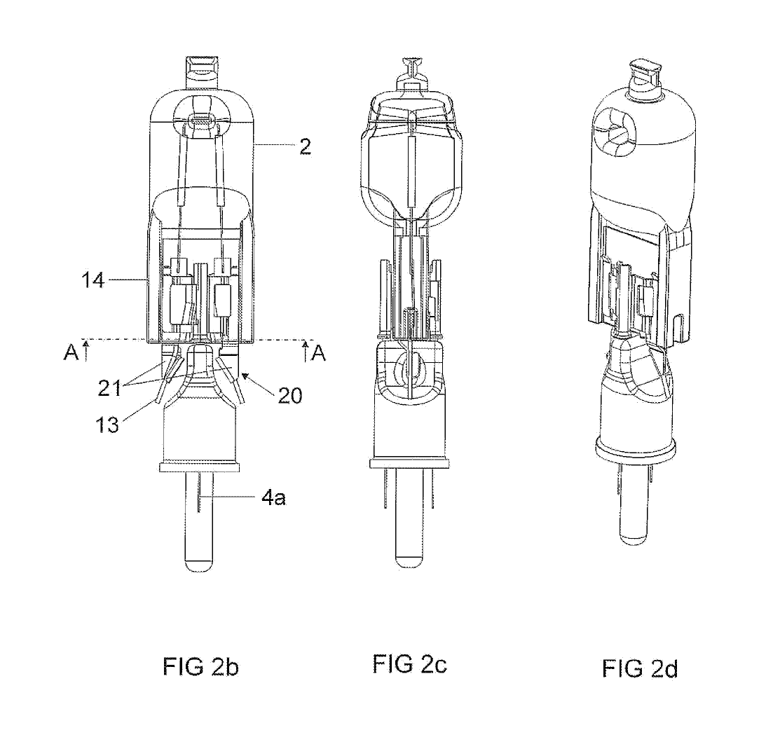

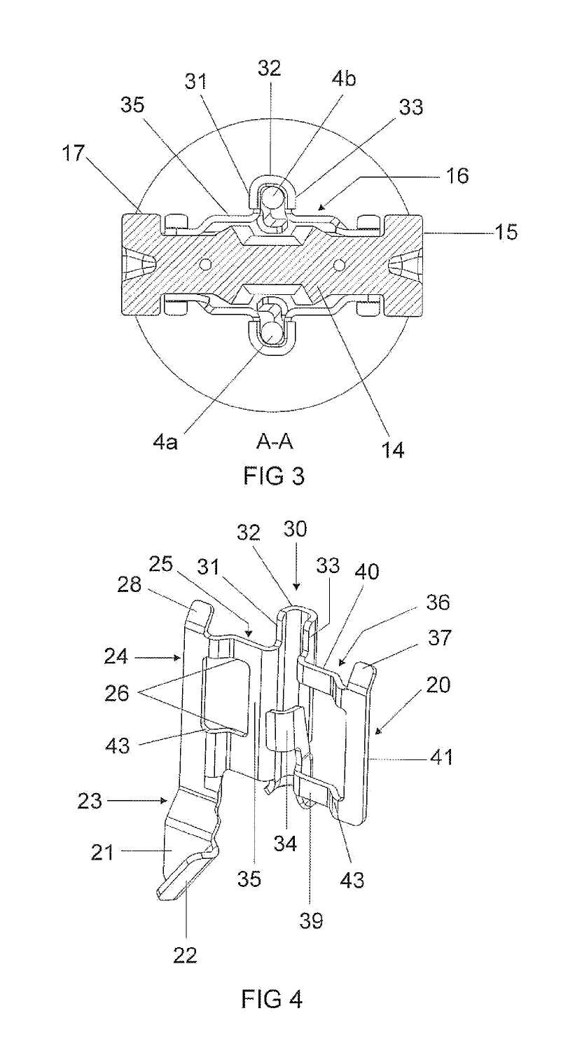

The built-in lamp 2 is held by two assembly clips 20, see FIGS. 2 to 4. The two assembly clips 20 are preferably identical but do not necessarily have to be. Each includes a contact face 21 for the outer supply lead 13, which is substantially formed as a beveled disk. A protrusion 22 is bent along the bevel by about 90° toward the face of the disk. The outer supply lead 13 is bent outwards at this protrusion 22.

The disk 21 forms the free end of a slat-like contact part 23. This in turn is substantially the downward extension of a longitudinal strut 24. This first longitudinal strut 24 is part of a frame part 25 which also comprises a second longitudinal strut 35 and cross struts 26 and 27 connecting them. A threading aid 28 is bent upwards toward the pinch 14 at the first longitudinal strut 24. The cross struts are slightly undulating.

The second longitudinal strut 35 is directly connected to a hollow rail 30 which is U-shaped in cross-section. The first side wall 31 of the hollow rail is directly attached to the second longitudinal strut 35 at about 90°. A top wall 32 is attached thereto which is arranged substantially parallel to the frame part 25. The second wall 33 attaches thereto and is bent back again toward the plane of the frame part. The hollow rail 30 can also be continuously arched, so there is a fluid transition between side walls and top wall.

In the illustrated exemplary embodiment the second wall and some of the top wall are incomplete. A relatively large recess 40 is provided approximately in the center, from which a clamping part 34 obliquely projects into the channel formed by the hollow rail. The purpose of the clamping part 34 is provisional retention of the base contact 4a or 4b introduced into the hollow rail channel.

The assembly clip 20 also includes a second frame part 36, wherein it is primarily a matter of a spring part 37. The second frame part 36 includes two cross struts 39 and 40 in this case as well as a remote longitudinal strut 41. A longitudinal strut adjacent to the hollow rail 30 is dispensed with in favor of the clamping part, it may, however, also be present for improved stability. The spring part 37 sits like a hood on the upper end of the remote longitudinal strut 41.

Both frame parts 25, 36 are undulating in that the cross struts are each provided with an oblique slope 43.

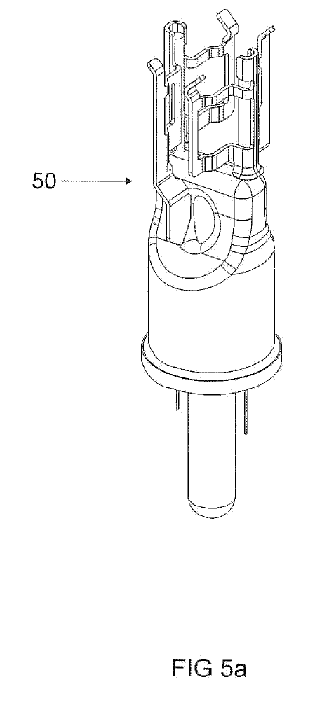

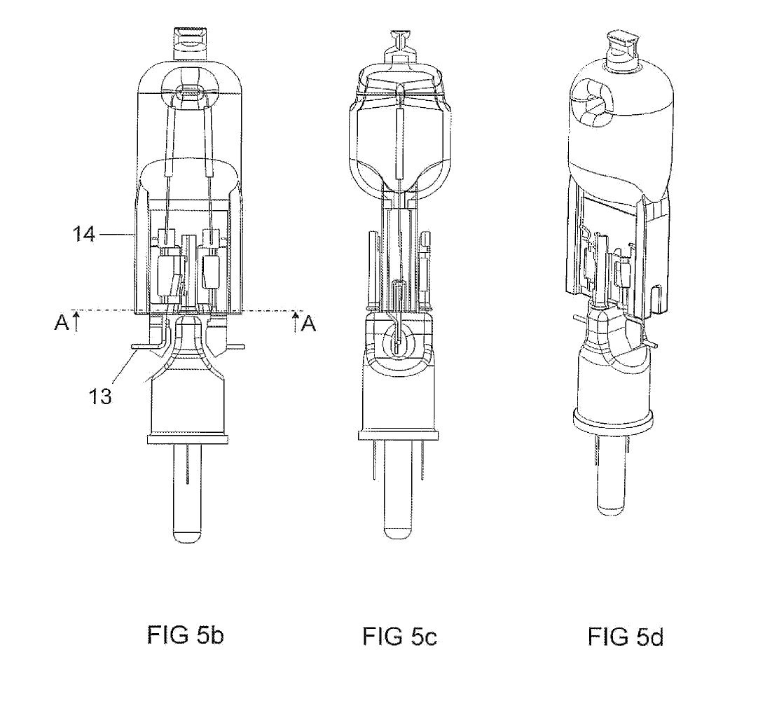

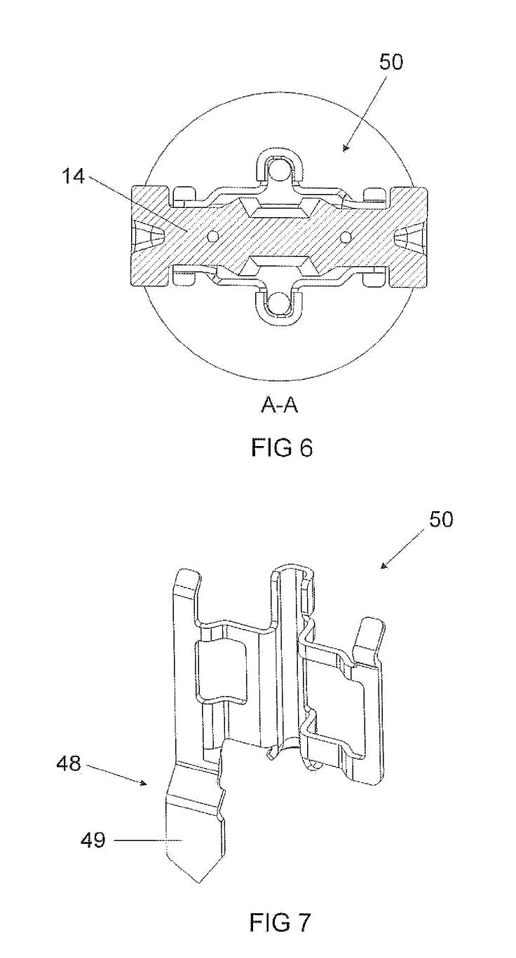

In a further exemplary embodiment according to FIGS. 5 to 7 the assembly clip 50 is in principle designed similar to that in the first exemplary embodiment. However, the contact disk 48 is designed so as to be approximately straight and spade-shaped 49 at the end. In this case the power supply lead 13 applied thereto is bent about approximately 90° toward the axis A, see FIG. 5b.

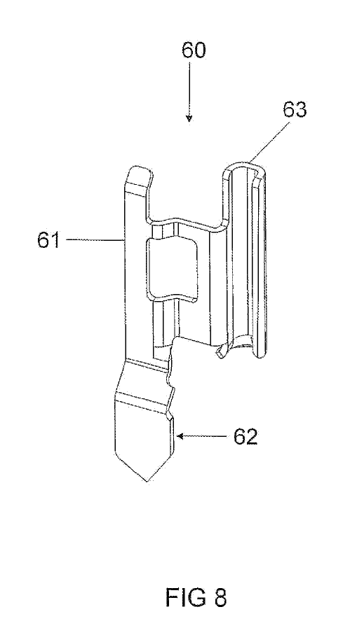

FIG. 8 shows a further simple exemplary embodiment. Here the assembly clip 60 consists only of the first frame part 61 with contact part 62 and hollow rail 63, and dispenses with a second frame part for stabilization.

Clips of this kind are assembled in such a way that the two clips 20 are joined to the base contacts 4a and 4b protruding at the plate base 4 (FIG. 2a) and are retained there, possibly provisionally, by the clamping part 34. A permanent connection between clip 20 and base contact 4a, 4b is achieved by laser welding, etc. A built-in lamp 2 is then inserted between the two clips 20 (FIG. 2b). The outer power supply leads 13 are bent in the process, either automatically by the protrusion or by means of a tool. The outer power supply leads 13 are then welded, by means of a laser, etc., to the clip 20 in the region of the contact face 21.

1. An electrical lamp, comprising:
an outer bulb and a built-in lamp arranged therein, and a longitudinal axis, a base being attached to the outer bulb,
the built-in lamp being fitted with a pinch from which at least one outer power supply lead protrudes which, in turn, is electrically conductively connected by a connecting means to a supply cable, hereinafter called a base pin, extending upwards from the base
wherein the connecting means is an assembly clip which comprises a frame part, the frame part connecting a hollow rail to a contact part, the contact part being connected to the outer power supply lead and the hollow rail being connected to the base pin.

2. The lamp as claimed in claim 1,
wherein the hollow rail has a first side wall, a top wall and a second side wall.

3. The lamp as claimed in claim 2,
wherein the second wall is fitted with a clamping part which projects into the channel formed by the hollow rail.

4. The lamp as claimed in claim 1,
wherein the frame part substantially comprises two longitudinal struts and two cross struts, the hollow rail attaching to the second longitudinal strut.

5. The lamp as claimed in claim 1,
wherein the contact part attaches to the first longitudinal strut as an extension and is fitted with a contact face.

6. The lamp as claimed in claim 5,
wherein the contact face is spade-shaped.

7. The lamp as claimed in claim 5,
wherein the contact face is beveled at the side, a protrusion being bent off at the bevel.

8. The lamp as claimed in claim 1,
wherein a second frame part is attached to the hollow rail and has at least one cross strut and a remote longitudinal part which runs parallel to the corresponding parts of the first frame part.

9. The lamp as claimed in claim 8,
wherein a spring part is attached to the extension of the remote longitudinal strut.

10. The lamp as claimed in claim 1,
wherein the outer bulb is terminated by means of a plate base from whose end the base pins project.
